(19) United States
(12) Patent Application Publication
(10) Pub. No.: US 2026/0006122 A1
(43) Pub. Date: Jan. 1, 2026

(54) Mobile Phone Storage Assembly For Driver Safety in Vehicles

(71) Applicant: Zach Cooper, Hayden Lake, ID (US)

(72) Inventor: Zach Cooper, Hayden Lake, ID (US)

(21) Appl. No.: 18/756,495

(22) Filed: Jun. 27, 2024

(51) Int. Cl. H04M 1/72463; B60R 7/08; H04M 1/04; H04M 1/60; H04M 1/72409; H04M 1/72412

(52) U.S. Cl. CPC H04M 1/724634; B60R 7/08; H04M 1/04; H04M 1/6075; H04M 1/724098; H04M 1/72412

(57) ABSTRACT

A mobile phone storage assembly includes a housing, an electromagnetic locking assembly, a wireless charger, a microprocessor, and a wiring assembly. The housing includes a case and a cover pivotably attached to the case. The locking assembly includes a first member attached to the case and a second member attached to the cover. The charger is mounted in the case and is operatively connected to the locking assembly to actuate the locking assembly upon charging of a mobile phone. The microprocessor is mounted in the case and operatively connected to the charger and the locking assembly, and is wirelessly pairable to a mobile phone to detect the presence thereof. The wiring assembly connects the microprocessor to a vehicle ignition system. The microprocessor sends a signal to activate the vehicle ignition system when the case has been locked and a paired mobile phone in the case is being charged.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to mobile phone driver safety devices and more particularly pertains to a new mobile phone storage assembly for preventing access to a mobile phone while driving to prevent a driver from holding the phone or otherwise manually engaging with the phone, such as texting, while driving.

### (2) Description of Related Art Including Information Disclosed Under 37 CFR 1.97 and 1.98

The prior art relates to mobile phone driver safety devices. The prior art, as best understood, does not disclose a mobile phone safety system for vehicles that is comprised of a secure compartment that is installed within a motor vehicle and contains a phone interface module which is used to prevent the vehicle from starting unless the phone is stowed within the compartment. The system will also restrict functions of the phone if it is removed from the compartment while the vehicle is in use.

### BRIEF SUMMARY OF THE INVENTION

An embodiment of the disclosure meets the needs presented above in a mobile phone storage assembly generally comprising a housing, an electromagnetic locking assembly, a wireless charger, a microprocessor, and a wiring assembly. The housing includes a case and a cover pivotably attached to the case. The electromagnetic locking assembly includes a first member attached to the case and a second member attached to the cover. The wireless charger is mounted in the case and is operatively connected to the locking assembly to actuate the locking assembly upon charging of a mobile phone. The microprocessor is mounted in the case and operatively connected to the charger and the locking assembly, and is wirelessly pairable to a mobile phone to detect the presence thereof in a vehicle. The wiring assembly connects the microprocessor to a vehicle ignition system. The microprocessor sends a signal to activate the vehicle ignition system when the microprocessor receives input that the case has been locked and a paired mobile phone in the case is being charged.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a mobile phone storage assembly according to an embodiment of the disclosure.

FIG. 2 is a front view of an embodiment of the disclosure.

FIG. 3 is a side view of an embodiment of the disclosure.

FIG. 4 is a perspective view of an embodiment of the disclosure.

FIG. 5 is a perspective view of an embodiment of the disclosure.

FIG. 6 is a front view of an embodiment of the disclosure in use.

FIG. 7 is a box diagram of an embodiment of the disclosure.

### DETAILED DESCRIPTION OF THE INVENTION

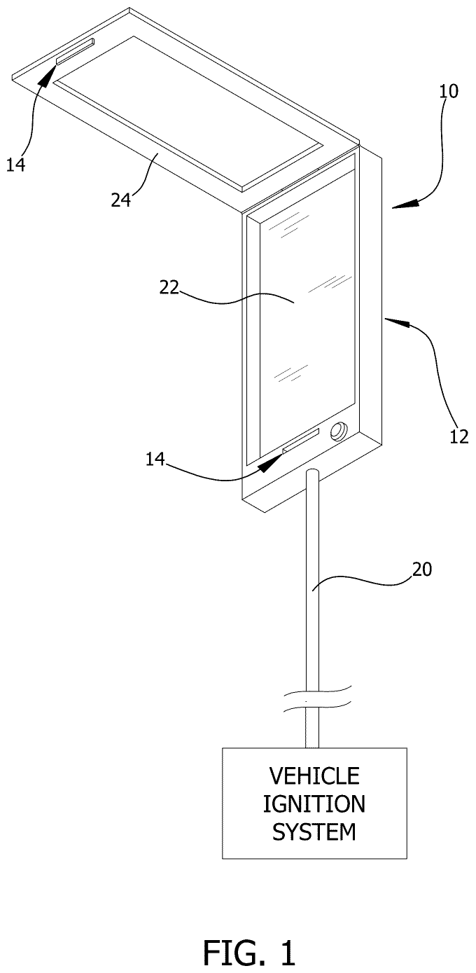

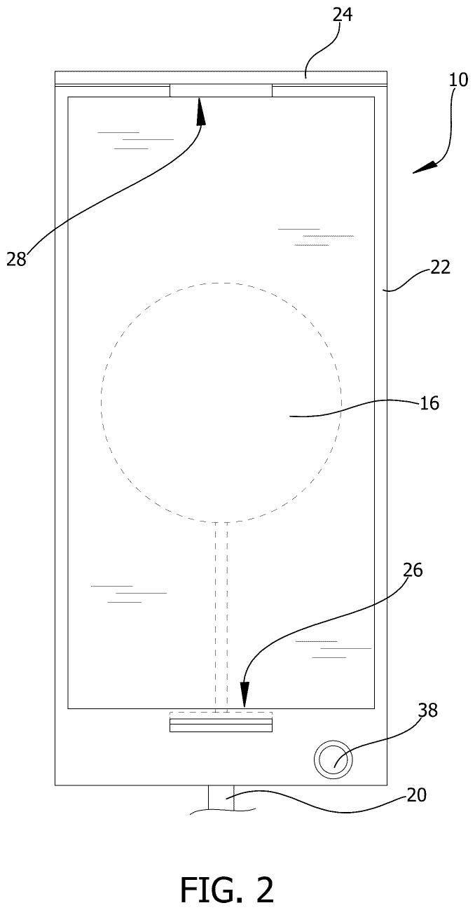

With reference now to the drawings, and in particular to FIGS. 1 through 7 thereof, a new mobile phone storage assembly embodying the principles and concepts of an embodiment of the disclosure and generally designated by the reference numeral 10 will be described.

As best illustrated in FIGS. 1 through 7, the mobile phone storage assembly 10 generally comprises a housing 12, an electromagnetic locking assembly 14, a wireless charger 16, a microprocessor 18, and a wiring assembly 20. The housing 12 includes a case 22 and a cover 24 pivotably attached to the case 22. The electromagnetic locking assembly 14 includes a first member 26 attached to the case 22 and a second member 28 attached to the cover 24. The wireless charger 16 is mounted in the case 22 and is operatively connected to the locking assembly 14 to actuate the locking assembly 14 upon charging of a mobile phone. The microprocessor 18 is mounted in the case 22 and operatively connected to the charger 16 and the locking assembly 14. The microprocessor 18 is wirelessly pairable to a mobile phone to detect the presence thereof in a vehicle. The wiring assembly 20 connects the microprocessor 18 to a vehicle ignition system. The microprocessor 18 sends a signal to activate the vehicle ignition system when the microprocessor 18 receives input that the case 22 has been locked and a paired mobile phone in the case 22 is being charged.

The cover 24 includes a viewing opening 30 to permit viewing of a screen of a mobile phone in the case 22. The opening 30 can be completely open or could possibly include a clear protective sheet. A power source, such as a battery, can be located in the housing 12. In another possible embodiment, the power source could be a charging cable connected to a charging port in the vehicle.

The first member 26 of the locking assembly 14 is a magnetic insert 32 and the second member 28 is an electromagnet lock 34 and receptacle 36 for the magnetic insert 32. Other locking assemblies, such as mechanical locks, are within the scope of the disclosure.

In one possible embodiment, the microprocessor 18 is designed to restrict operation of a paired mobile phone to hands-free mode when placed in the case 22. In another possible embodiment, the microprocessor 18 is designed to receive and store movement data of a paired mobile phone corresponding to speed and travel of a vehicle. The data could be automatically transmitted or selectively retrieved using a computer application on a computer or mobile device, which data could then be used by others to monitor and evaluate the driving behaviors of the owner of the mobile phone.

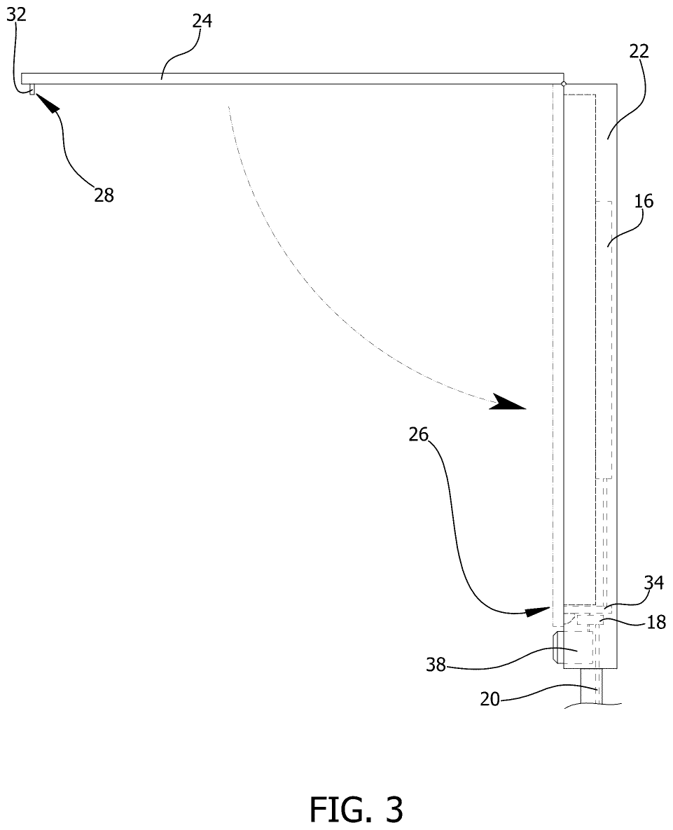

In the exemplary embodiment shown in FIG. 3, the mobile phone storage assembly 10 further includes an override switch 38 mounted in the case 22 and operatively connected to the microprocessor 18 to activate the vehicle ignition system when a paired mobile phone is not detected by the microprocessor 18. The override switch 38 would be used when the mobile phone is not present, such as if the owner lost the phone or it was damaged, or when another driver is using the vehicle and does not have the paired mobile phone.

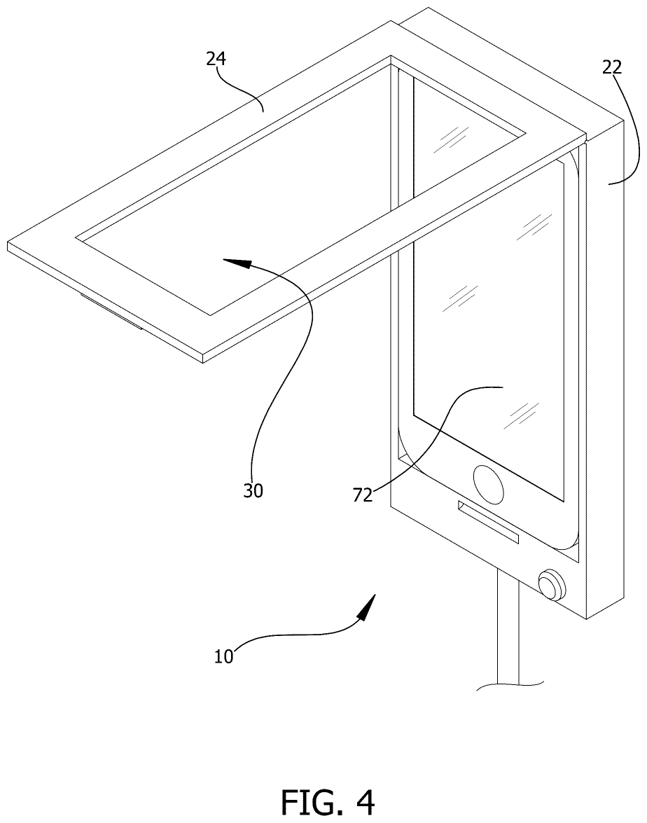

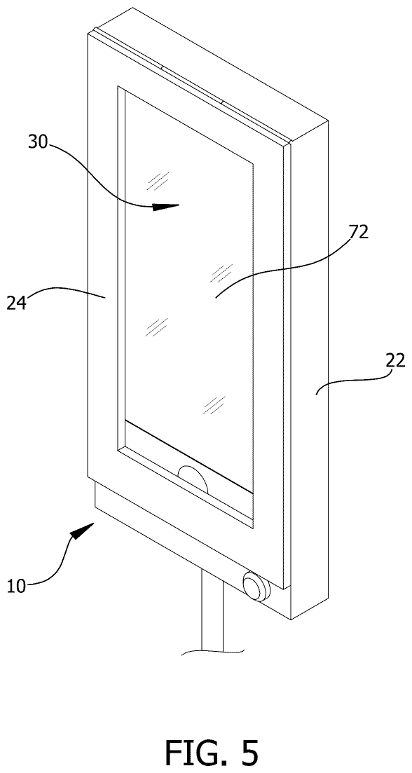

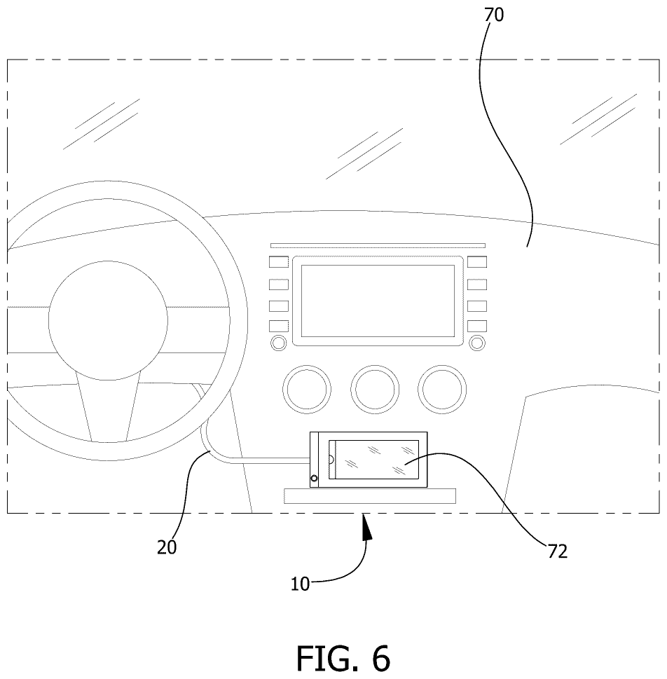

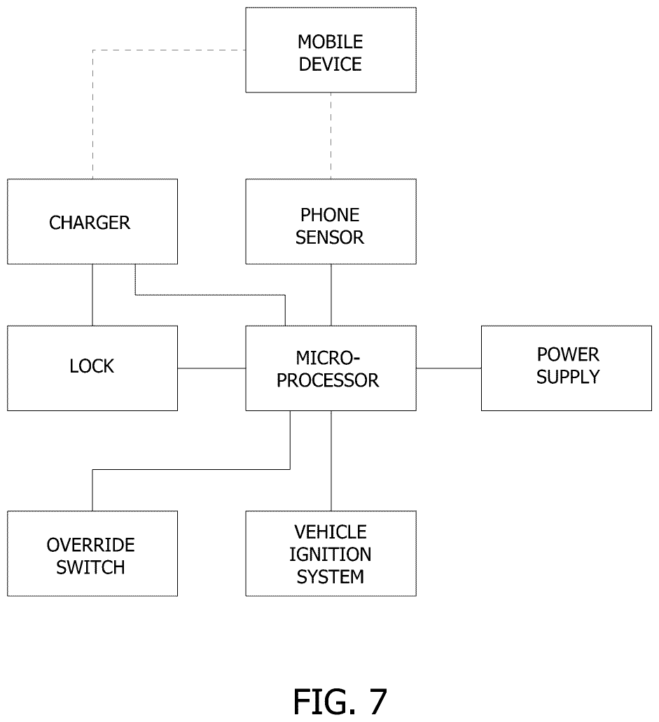

As shown in FIG. 6 and outlined in FIG. 7, the mobile phone storage assembly 10 is wired to the vehicle ignition system and will only activate the vehicle ignition system to permit driving of a vehicle 70 when a mobile phone 72 is locked in the housing 12 and being charged. To do so, the mobile phone 72 is first paired with the microprocessor 18 in a known manner. This pairing allows the microprocessor 18 to automatically detect when the mobile phone 72 is in the vehicle 70. The user then opens the housing 12 by pivoting the cover 24 and then places the mobile phone 72 in the housing 12, as shown in FIG. 4. The user then closes the cover 24 and thereby engages the locking assembly 14, as shown in FIG. 5. This process is also shown in FIG. 3. When the mobile phone 72 is placed in the case 22, the charger 16 begins wirelessly charging the mobile phone 72. This charging causes the actuation of the locking assembly 14. The microprocessor 18 detects the charging and the actuation of the locking assembly 14, as well as the presence of the paired mobile device. When all of these conditions are met, the microprocessor 18 activates the vehicle ignition system to allow the user to operate the vehicle 70. If the presence of the mobile phone 72 is not detected by the microprocessor 18, then the override switch 38 may be utilized to activate the vehicle ignition system. Since the main purpose of the mobile phone storage assembly 10 is to prevent the owner of the mobile phone 72 from manually holding or using the mobile phone 72 while driving, allowing activation of the vehicle ignition system when the mobile phone 72 is not present does not hinder this purpose while still allowing any driver not possessing the mobile phone 72 to operate the vehicle 70. In addition, the presence of other mobile phones, such as those used by passengers, will not affect the operation of the mobile phone storage assembly 10. In one possible embodiment, the microprocessor 18 could be programmed to pair with multiple mobile phones to thereby prevent multiple drivers of a single car from handling their mobile phones while driving. In another possible embodiment, the microprocessor 18 could be programmed to completely disable the mobile phone 72 or only allow emergency calling if the microprocessor 18 detects disengagement of the locking assembly 14 while driving, such as by switching the mobile phone 72 to airplane mode or SOS mode.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A mobile phone storage assembly comprising:
a housing comprising a case and a cover pivotably attached to said case;
an electromagnetic locking assembly comprising a first member attached to said case and a second member attached to said cover;
a wireless charger mounted in said case and being operatively connected to said locking assembly to actuate said locking assembly upon charging of a mobile phone;
a microprocessor mounted in said case and operatively connected to said charger and said locking assembly, wherein said microprocessor is wirelessly pairable to a mobile phone to detect the presence thereof in a vehicle; and
a wiring assembly connecting said microprocessor to a vehicle ignition system, wherein said microprocessor sends a signal to activate said vehicle ignition system when said microprocessor receives input that said case has been locked and a paired mobile phone in said case is being charged.

2. The mobile phone storage assembly of claim 1, wherein said cover comprises a viewing opening to permit viewing of a screen of a mobile phone in said case.

3. The mobile phone storage assembly of claim 1, wherein said first member comprises a magnetic insert and said second member comprises an electromagnet lock and receptacle for said magnetic insert.

4. The mobile phone storage assembly of claim 1, wherein said microprocessor is configured to restrict operation of a paired mobile phone to hands-free mode when placed in said case.

5. The mobile phone storage assembly of claim 1, wherein said microprocessor is configured to receive and store movement data of a paired mobile phone corresponding to speed and travel of a vehicle.

6. The mobile phone storage assembly of claim 1, wherein the mobile phone storage assembly further comprises an override switch mounted in said case and operatively connected to said microprocessor to activate said vehicle ignition system when a paired mobile phone is not detected by said microprocessor.

7. A mobile phone storage assembly comprising:
a housing comprising a case and a cover pivotably attached to said case, wherein:
said cover comprises a viewing opening to permit viewing of a screen of a mobile phone in said case;
an electromagnetic locking assembly comprising a first member attached to said case and a second member attached to said cover, wherein:
said first member comprises a magnetic insert and said second member comprises an electromagnet lock and receptacle for said magnetic insert;
a wireless charger mounted in said case and being operatively connected to said locking assembly to actuate said locking assembly upon charging of a mobile phone;
a microprocessor mounted in said case and operatively connected to said charger and said locking assembly, wherein said microprocessor is wirelessly pairable to a mobile phone to detect the presence thereof in a vehicle, wherein:
said microprocessor is configured to restrict operation of a paired mobile phone to hands-free mode when placed in said case,
said microprocessor is configured to receive and store movement data of a paired mobile phone corresponding to speed and travel of a vehicle;
a wiring assembly connecting said microprocessor to a vehicle ignition system, wherein said microprocessor sends a signal to activate said vehicle ignition system when said microprocessor receives input that said case has been locked and a paired mobile phone in said case is being charged; and
an override switch mounted in said case and operatively connected to said microprocessor to activate said vehicle ignition system when a paired mobile phone is not detected by said microprocessor.
